(19) United States
(12) Patent Application Publication
(10) Pub. No.: US 2005/0235572 A1
(43) Pub. Date: Oct. 27, 2005

(54) Insert,weather strip and production method of weather strip for automobile

(75) Inventors: Yasunori Kamei, Hiroshima-shi (JP); Tsuyoshi Kounobu, Hiroshima-shi (JP); Toshinari Tennoh, Hiroshima-shi (JP)

Correspondence Address: FRISHAUF, HOLTZ, GOODMAN & CHICK, PC, 220 5TH AVE FL 16, NEW YORK, NY, 10001-7708, US

(73) Assignee: Nishikawa Rubber Co., Ltd., Hiroshima-ken (JP)

(21) Appl. No.: 11/045,464

(22) Filed: Jan. 27, 2005

(30) Foreign Application Priority Data
Apr. 22, 2004 (JP) JP2004-126952
Nov. 9, 2004 (JP) JP2004-325478

(51) Int. Cl. E05F 11/38

(52) U.S. Cl. 49/490.1

(57) ABSTRACT

There is provided a weather strip embedding an insert 1 which comprises a plural number of arch-like plates 11 formed in a roughly reversed-U shape in section and positioned in parallel forming a certain space between each plate, and band-like connecting portions 12 for connecting each end edge of the arch-like plates 11, wherein the arch-like plates 11 are disconnected by cutting and removing the band-like connecting portions 12.

### BACKGROUND OF THE INVENTION

This invention relates to a weather strip which is installed to an opening edge of an automobile body in order to seal a gap between the body and an open-close member by making a elastic contact with the open-close member which is constructed opposing to the automobile body.

As illustrated in FIG. 7, as an example of an opening edge of an automobile body, there is an opening edge 32 in a trunk room 31, and a weather strip 33 is installed to the opening edge 32. As illustrated in FIG. 8, the weather strip 33 is composed of an installation base member 33 and a hollow seal member 4. The installation base member 3 is made of solid rubber or micro foamed material and is formed in a reversed-U shape and is installed to the opening edge 32. The hollow seal member 4 is made of sponge rubber and is integrally formed with the installation base member 3 and makes a elastic contact with an opposing trunk lid 34 when the trunk lid 34 is in a closed position.

An insert 2 is embedded in the installation base member 3 for providing rigidity, and a plural number of holding lips 5 made of solid rubber (or sponge material) are formed inside thereof for holding the opening edge 32 of the trunk room 31.

As illustrated in FIG. 9, the insert 2 is formed such that a plural number of arch-like plates 21 are placed in parallel, and each arch-like plate 21 is disconnectedly embedded in a weather strip 33. Therefore, when the weather strip 33 is bent, the insert 2 does not interfere the bending operation, and the flexibility of the weather strip in a longitudinal direction can be obtained.

In order to form the weather strip having the insert as described above, the following processes are, in general, carried out.

First, as illustrated in FIG. 10, the insert 2, which comprises a plural number of strip-of-paper-like flat plates 23 wherein neighboring flat plates 23 are connected by a connecting portion 22 at both left and right sides in FIG. 10 or either left side or right side thereof, and rubber forming material of a weather strip main body are formed by an extrusion molding, thereby producing a weather strip in a planate form embedding the insert 2 in the weather strip body. Following this process, the planate weather strip is repeatedly bent to disconnect the neighboring flat plates 23 by breaking the connecting portions 22. Then, the planate weather strip is formed in a roughly reversed-U shape in section by bending it along the dotted lines “A” and “B” shown in FIG. 10.

By completing the above described processes, each arch-like plate 21 is disconnectedly embedded inside the weather strip.

A metal made insert has been used as the insert 2 is comprised for a reason to provide rigidity in the installation base member 3 (see, for example Unexamined Japanese Patent Publication No. 9-39684). However, the metal made insert makes the weather strip increase its weight, so that there has been proposed a resin made insert for a purpose of weight saving.

However, in case the resin made insert is applied, it is necessary to increase the thickness “L” of the insert 2 in order to provide enough rigidity equal to that of the metal made insert, and it is also necessary to increase the size of the connecting portion 22 in order for the insert 2 not to break in a longitudinal direction during extrusion molding.

Nevertheless, by taking such technique, the connecting portions 22 do not easily broken by a conventional method of repeatedly bending the weather strip. Further, there cannot be obtained enough flexibility since each arch-like plate 21 is contacting with neighboring plates 21.

### SUMMARY OF THE INVENTION

It is therefore an object of this invention to solve the above mentioned problems and to provide products and method in which neighboring arch-like plates of an insert embedded in a weather strip can be easily disconnected thereby providing the weather strip enough flexibility in a longitudinal direction in obtaining an insert made of thermoplastic resin or thermoplastic elastomer having enough rigidity equal to a metal made insert.

In order to achieve the above mentioned object, there is provided, according to a first aspect of the invention, an insert of a weather strip for an automobile made of thermoplastic resin or thermoplastic elastomer embedded in a weather strip. The insert comprises a plural number of arch-like plates (11) formed in a roughly reversed-U shape in section and positioned in parallel with a certain space between each plate, and band-like connecting portions (12) for connecting both ends of each of the arch-like plate (11) in a longitudinal direction. The arch-like plates (11) are easily disconnected by removing said band-like connecting portions (12).

Further, according to an insert of a weather strip for an automobile in a second aspect of the invention, elastomer is filled in spaces in a plural number of the arch-like plates (11) disclosed in the first aspect of the invention.

According to a third aspect of the invention, there is provided a weather strip (33) for an automobile embedding an insert (1) which is made of thermoplastic resin or thermoplastic elastomer. The insert (1) comprises a plural number of arch-like plates (11) formed in a roughly reversed-U shape in section and positioned in parallel with a certain space between each plate, and band-like connecting portions (12) for connecting both ends of each of the arch-like plate (11) in a longitudinal direction. The arch-like plates (11) are easily disconnected by removing the band-like connecting portions (12) during a forming operation of the weather strip (33).

According to a fourth aspect of the invention, there is provided a production method of a weather strip (33) for an automobile comprising the steps of forming an insert (1) made of thermoplastic resin or thermoplastic elastomer comprising a plural number of arch-like plates (11) formed in a roughly reversed-U shape in section and positioned in parallel with a certain space between each plate, and band-like connecting portions (12) for connecting both ends of each of plural number of said arch-like plates (11) in a longitudinal direction; then co-extrusion for the insert (1) and forming material of a weather strip main body in a manner that the band-like connecting portions (12) expose out of end edges of the reversed-U shape portions of the weather strip (33); and, removing the band-like connecting portions (12) to disconnect the arch-like plates (11) inside the weather strip (33).

Each numeral in the parenthesis indicates a corresponding element or matter mentioned in the under-mentioned most preferred embodiment of the invention and the drawings.

According to the invention, there is provided the insert of a weather strip for an automobile which comprises a plural number of arch-like plates which are positioned in parallel with a certain space between each plate, and the bank-like connecting portions for connecting the end edges of each of the arch-like plates in a longitudinal direction, wherein the band-like connecting portions are removed after co-extrusion for the insert and the material forming of the weather strip main body, so that the arch-like plates embedded inside the weather strip can be easily disconnected. For example, each arch-like plate can be disconnected inside the weather strip by a process of co-extrusion for the insert and the forming material of the weather strip main body in a manner that the band-like connecting portions expose out of the U-shaped end edges of the weather strip followed by a process of removing the band-like connecting portions.

Therefore, even in case the insert is formed thick, the neighboring arch-like plates can be easily disconnected, so that it is possible to pursue a weight saving of the weather strip by forming the insert with thermoplastic resin or thermoplastic elastomer with enough rigidity equal to a metal made insert.

Further, according to the invention, the operating efficiency can be improved compared to the prior example because the weather strip is extruded in a roughly reversed-U shape in section from the beginning whereas in the prior example the weather strip is initially extruded in a planate form and it is bent in a roughly reversed-U shape in section after breaking the connecting portions thereof.

Further, according to the invention, there can provide enough flexibility in the weather strip because after removing the band-like connecting portions, the connecting portions which existed in the prior art (the connecting portions 22 shown in FIG. 9) do not exist between the neighboring plates and some spaces exist in stead, and thus the neighboring arch-like plates do not hit with each other when the weather strip is bent.

Further, according to the invention, the tensile strength of the weather strip in a longitudinal direction can be improved because the spaces formed between the neighboring arch-like plates are filled with elastomer having satisfied hardness prior to the co-extrusion for the insert and the forming material of the weather strip main body. Moreover, the design performance can be improved because of filling the elastomer in the spaces, it can prevent concavities and convexities from being formed in the spaces between the arch-like plates during the extrusion molding process.

### BRIEF DESCRIPTION OF THE DRAWINGS

FIG. 1 shows an insert of a weather strip for an automobile according the preferred embodiment of the invention, wherein (a) is a plane view, (b) is a side view and (c) is a front view;

FIG. 2 shows the insert shown in FIG. 1 which is developed in planate, wherein (a) is a plane view and (b) is a front view;

FIG. 3 is a sectional view showing a weather strip according to the preferred embodiment of the invention, wherein (a) shows band-like connecting portions before they are removed and (b) shows the condition after the same portions are removed;

FIG. 4 is a sectional view showing a weather strip according to the preferred embodiment of the invention wherein the fracture surface is pressed by a forming jig;

FIG. 5 is a sectional view showing a weather strip according to the preferred embodiment of the invention wherein lips are provided to the installation base member;

FIG. 6 shows an insert of a weather strip for an automobile according to the preferred embodiment of the invention in which spaces formed between the arch-like plates are filled with elastomer, wherein (a) is a plane view and (b) is a side view;

FIG. 7 is a perspective view of an external appearance of an automobile wherein the trunk lid thereof is opened;

FIG. 8 is a sectional view showing a weather strip according to a prior example;

FIG. 9 shows an insert embedded in a weather strip according to a prior example wherein (a) is a plane view, (b) is a side view and (c) is a front view;

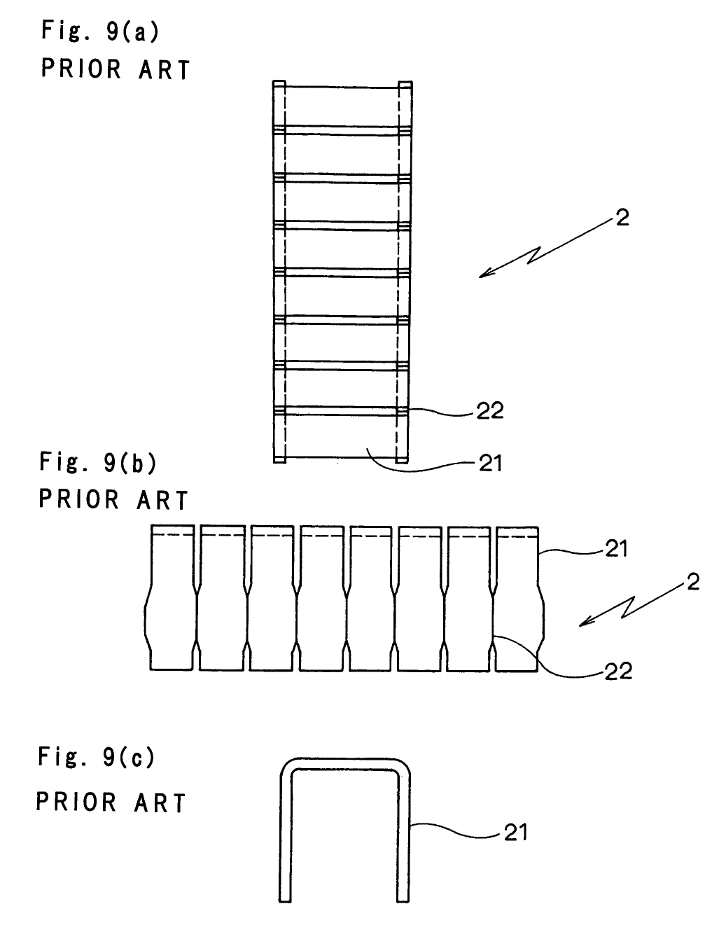

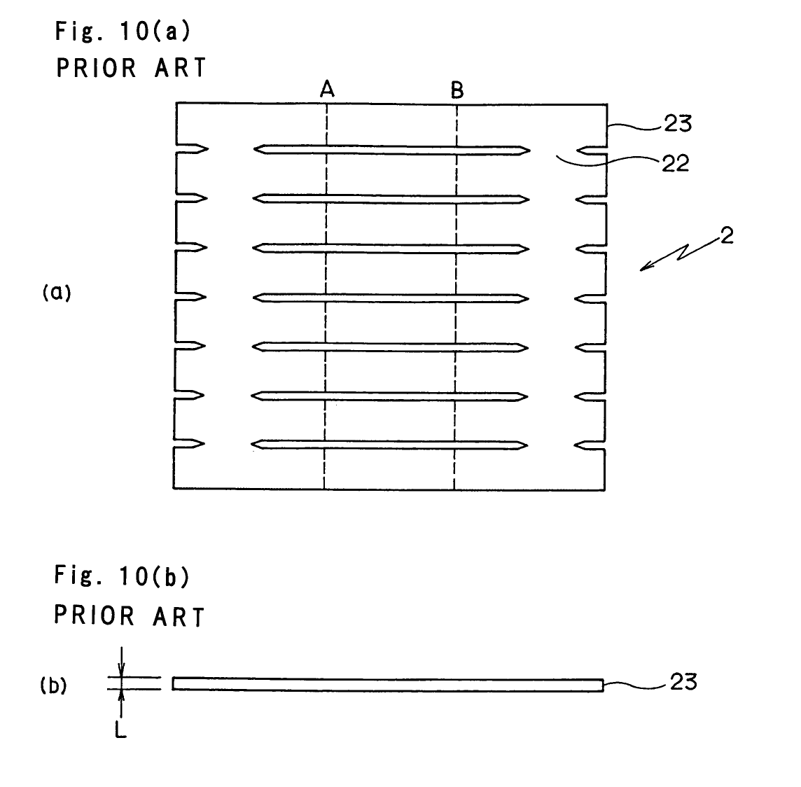

and, FIG. 10 shows the insert shown in FIG. 9 which is developed in planate wherein (a) is a plane view and (b) is an elevation view.

### DETAILED DESCRIPTION OF THE INVENTION

A weather strip according to the most preferred embodiment of the invention will be described referring to the drawings.

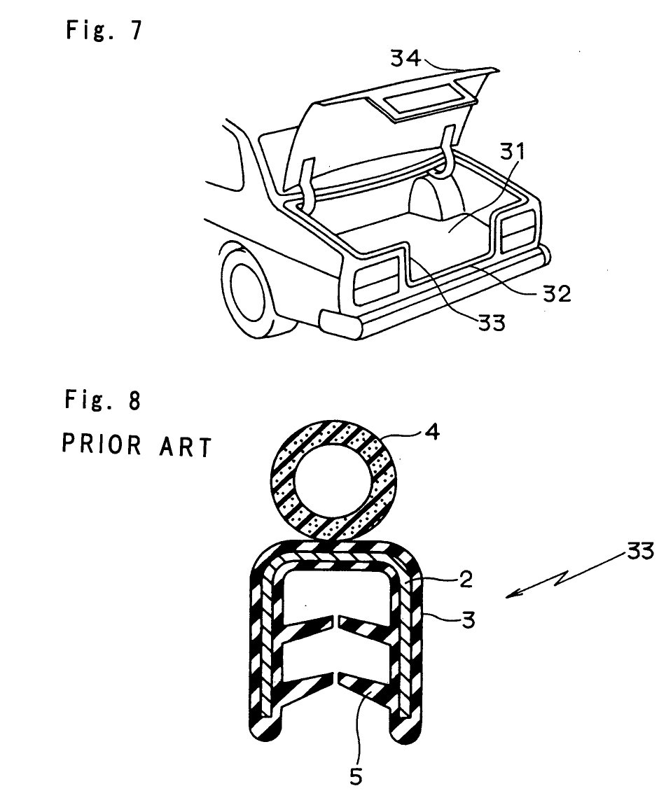

This embodiment exhibits a weather strip 33 which is installed to an opening edge 32 of a trunk room 31 of an automobile as such as shown in FIG. 7.

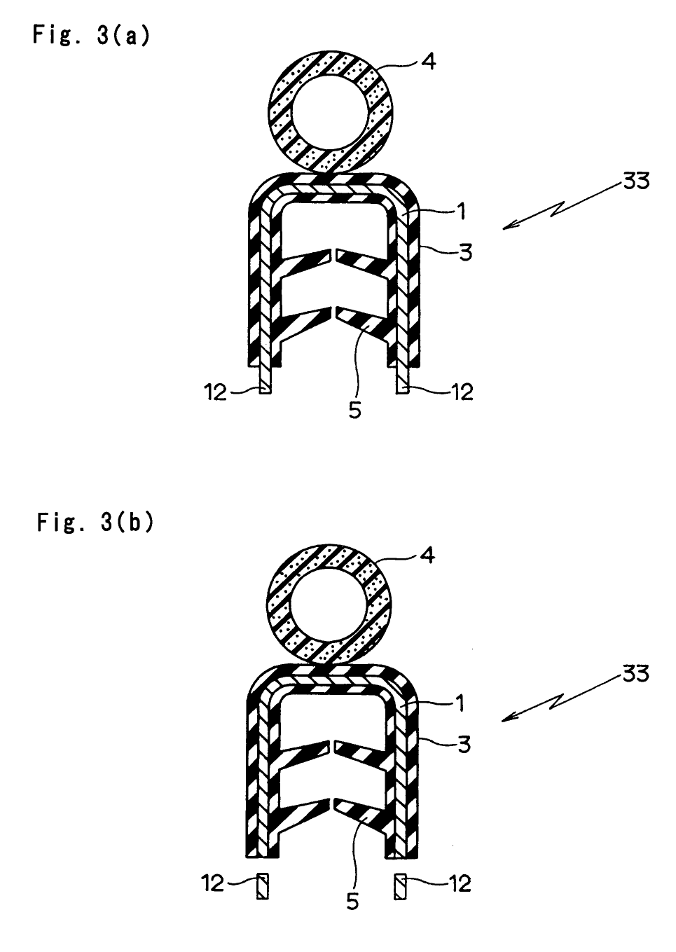

As illustrated in FIG. 3, the weather strip 33 comprises an installation base member 3 which is made of solid rubber or micro foamed material, and a hollow seal member 4 which is made of sponge rubber. There is embedded an insert 1 inside the installation base member 3 for providing rigidity.

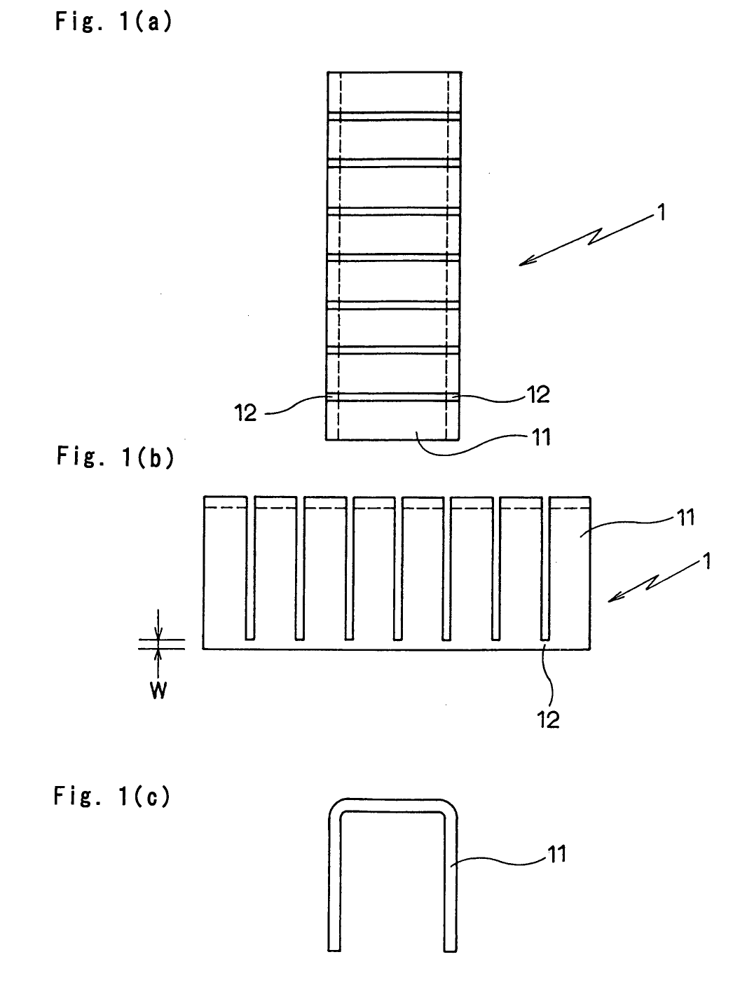

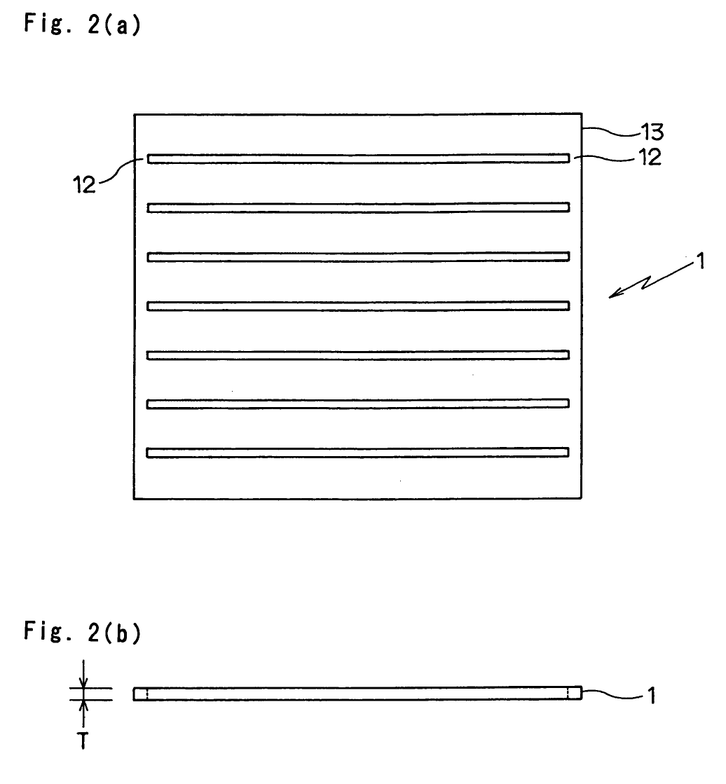

A structure of the insert 1 will be described referring to FIGS. 1 and 2. FIG. 1 (a) is a plan view of insert 1. FIG. 1 (b) is a side view of the insert 1, and FIG. 1 (c) is a front view of the insert 1. FIG. 2 shows the insert 1 which is developed in a planate form.

The insert 1 is made of thermoplastic resin or thermoplastic elastomer, and it comprises a plural number of arch-like plates 11, each of which is formed in a roughly reversed-U shape in section and are positioned in parallel with a certain space formed between each plate, and two band-like connecting portions 12 which connect both end edges of the arch-like plates 11. The band-like connecting portions 12 extends in a longitudinal direction. The width (W) of the insert 1 is formed to provide enough tensile strength in a longitudinal direction. The thickness (T) of the insert 1 is preferably formed thicker than an metal made insert in order to provide enough strength equal to that of the metal insert.

It should be noted that the insert 1 developed in a planate form is illustrated in FIG. 2 merely for an explanation of the invention although, in this embodiment, the insert 1 is not formed in a planate form and only the insert 1 formed in a roughly reversed-U shape is used.

The thermoplastic resin or thermoplastic elastomer forming the insert 1 is preferable to have the flexural modulus of 2000 MPa to 5000 MPa. In case the flexural modulus is less than 2000 MPa, the installation base member 3 formed in an U-shape becomes deficient in holding rigidity, and the weather strip 33 easily tends to fall from an automobile body after installation. In case the flexural modulus exceeds 5000 MPa, the cost of material increases prominently, although there is no problem from a practical standpoint of view, so that the flexural modulus is preferably less than 5000 MPa for production with lower cost.

Materials usable for the insert 1 are such as polyethylene, polypropylene, polystyrene, polyamide, thermoplastic elastomer olefin (TPO), thermoplastic elastomer styrene (TPS), thermoplastic elastomer urethane (TPU). In those materials, it is preferable to use polypropylene with the addition of filler for the reasons that it has the flexural modulus of 2000 MPa to 5000 MPa which is suitable for the insert 1 and that it is low in cost.

Referring to FIG. 3, a production method of a weather strip for an automobile embedding an insert 1 will be described.

First, there is formed an insert 1 with resin, which is formed in a roughly reversed-U shape in section from the beginning, and which comprises a plural number of arch-like plates 11 which are positioned in parallel with a certain space between each plate, and band-like connecting portions 12 which connect both end edges of the plates 11.

Then, the roughly reversed-U shaped insert 1 and forming material of a weather strip main body are co-extruded and the weather strip 33 as illustrated in FIG. 3 (a) is formed. In this process, the weather strip 33 is formed in such manner that either or both of the band-like connecting portions 12 of the insert 1 expose out of the U-shaped end edges of the installation base member 3.

And finally, the band-like connecting portions 12 exposed out of the installation base member 3 are cut and removed. By completing those processes, each of the arch-like plates 11 of the insert 1 embedded in the weather strip 33 are disconnected.

According to the insert of a weather strip for an automobile formed in the above mentioned method, the arch-like plates 11 embedded in the weather strip 33 can be easily disconnected by removing the band-like connecting portions 12 after co-extrusion molding the insert 1 and the forming material of the weather strip main body.

Therefore, there is no difficulty in disconnecting the arch-like plates 11 even if the thickness (T) of the insert 1 is formed larger than an insert made of metal for providing rigidity.

Further, in a process of forming the weather strip, the weather strip body is formed in a roughly reversed-U shape in section with the insert 1 from the beginning, so that the working efficiency can be improved compared to the prior example in which the weather strip is initially formed in a planate form and then it is repeatedly bent to break the connecting portions of the insert, followed by a process of bending in a roughly reversed-U shape in section to produce a final product.

Further, in case both of the band-like connecting portions 12 are removed, there is formed a certain space between each arch-like plate 11 while no connecting portions, which are formed in the prior example, are formed, so that when the weather strip is bent, the neighboring plates do not hit with each other, thereby providing high flexibility in the weather strip 33.

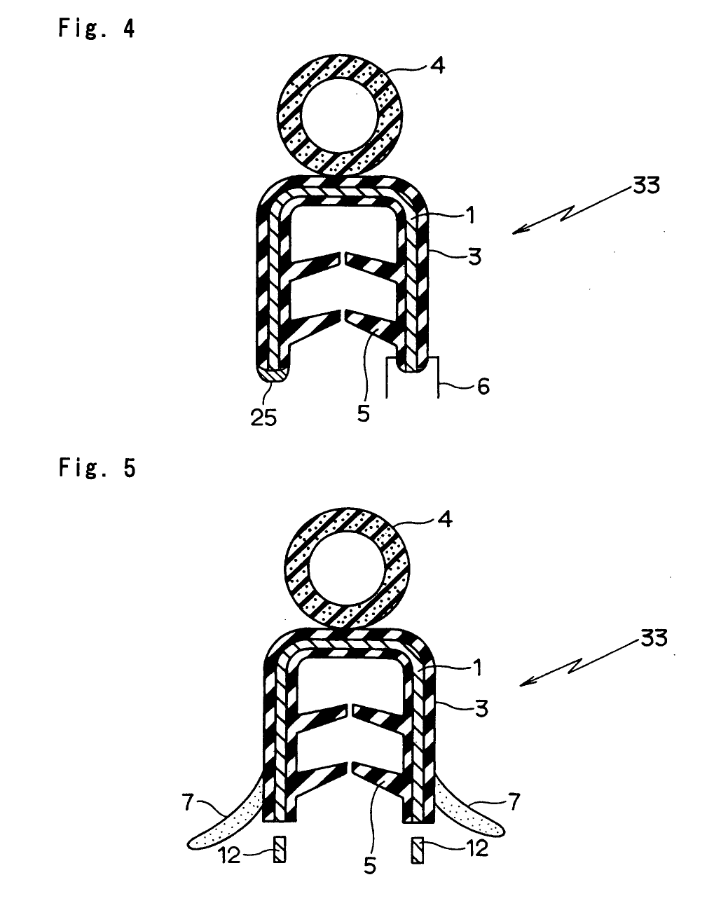

It should be noted that, as illustrated in FIG. 4, the exposed fracture surfaces of the weather strip 33 after cutting and removing the band-like connecting portions 12 can be improved in design performance by newly laminating elastomer 25 on the exposed fracture surfaces besides a method of pressing the forming jig 6 on the surface after partially melting by heat.

Further, as illustrated in FIG. 5, there is a product in an actual manner that the lips 7 are formed to support the installation base member 3 from outside and to seal water, and in such product, the fracture surfaces are not necessarily completed into smooth surfaces.

Further, according to the preferred embodiment of the invention, the installation base member 3 may be made of solid TPE (thermoplastic elastomer) such as thermoplastic elastomer olefin (TPO) and thermoplastic elastomer styrene (TPS), while the hollow seal portion 4 may be made of soft solid or formed TPE (thermoplastic elastomer).

Further, according to this embodiment, the band-like connecting portions 12 are exposed out of the U-shaped edge ends of the installation base member 12 in the extruding process, and then the exposed band-like connecting portions 12 are removed from the insert. Instead, the band-like connecting portions 12 can be exposed out of other parts other than the U-shaped end edges of the installation base member 12, followed by the process of removing the exposed portions 12.

Further, the band-like connecting portions 12 can be disconnected from the insert 1 while the insert 1 is embedded in the installation base member 3, and then the disconnected band-like connecting portions 12 can be drawn and removed from the installation base member 12.

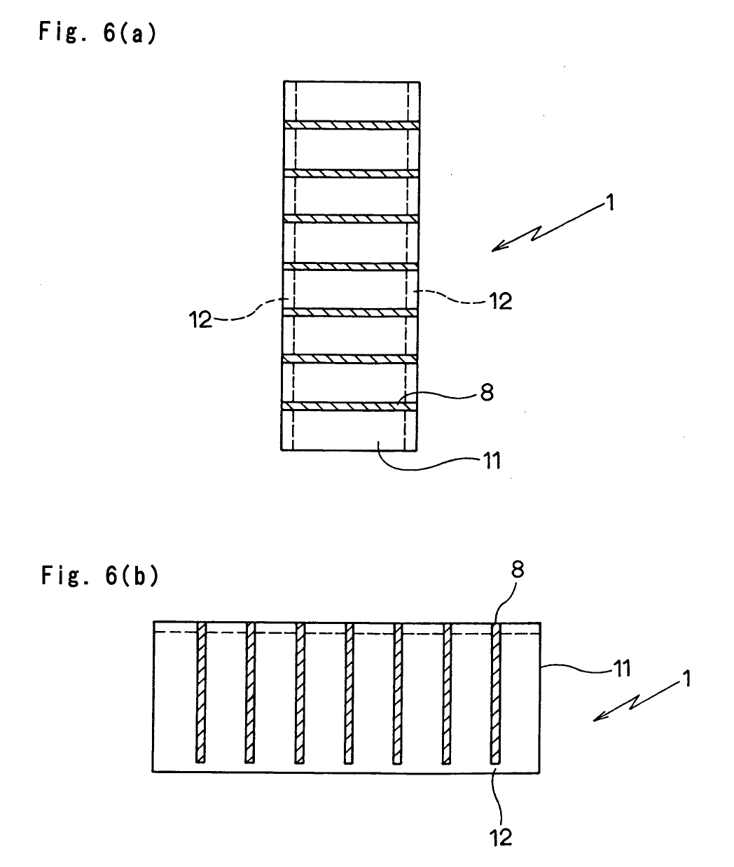

Furthermore, as illustrated in FIG. 6, spaces formed between each neighboring arch-like plates 11 forming the insert 1 can be filled with elastomer 8. The elastomer 8 used in this embodiment is preferable to have Shore A hardness of 20 degree or more and Shore D hardness of 50 degree or less. In case the elastomer 8 has Shore A hardness of less than 20 degree, there occurs a defect that the tensile strength of the weather strip in a longitudinal direction decreases. Further, if the hardness of the elastomer 8 is more than 50 degree in Shore D, there arises a problem that the flexibility of the weather strip deteriorates in installing the weather strip to a steel metal of an automobile body.

Materials usable for the elastomer 8 applied to fill the spaces are thermoplastic elastomer olefin (TPO), thermoplastic elastomer styrene (TPS), thermoplastic elastomer urethane (TPU), ethylene-propylene rubber, styrene-butadiene rubber, natural rubber and the like. In those materials, it is preferable to use thermoplastic elastomer olefin (TPO) and thermoplastic elastomer styrene (TPS) from a point of formability.

According to this, the tensile strength of the weather strip in a longitudinal direction can be improved. Further, in a process of co-extrusion molding of the insert 1 and the forming material of the weather strip main body, it can provide a weather strip with a higher design performance preventing any concavities and convexities from being formed in the spaces which will deteriorate the external appearance of the weather strip.

It should be noted that although this preferred embodiment discloses a weather strip used in a rear trunk of an automobile, the invention is not limited to such use, and it can be applied to any weather strip embedding an insert therein.

1. An insert of a weather strip for an automobile made of thermoplastic resin or thermoplastic elastomer embedded in a weather strip comprising,
a plural number of arch-like plates formed in a roughly reversed-U shape in section and positioned in parallel with a certain space between each plate;
and, band-like connecting portions for connecting both ends of each of said arch-like plate in a longitudinal direction;
wherein said arch-like plates are easily disconnected by removing said band-like connecting portions.

2. An insert of a weather strip for an automobile claimed in claim 1 wherein spaces in a plural number of said arch-like plates are filled with elastomer.

3. A weather strip for an automobile embedding an insert made of thermoplastic resin or thermoplastic elastomer which comprises a plural number of arch-like plates formed in a roughly reversed-U shape in section and positioned in parallel with a certain space between each plate, and band-like connecting portions for connecting both ends of each of said arch-like plate in a longitudinal direction wherein, said arch-like plates are easily disconnected by removing said band-like connecting portions during a forming operation of said weather strip.

4. A production method of a weather strip for an automobile comprising steps of:
forming an insert made of thermoplastic resin or thermoplastic elastomer comprising a plural number of arch-like plates formed in a roughly reversed-U shape in section and positioned in parallel with a certain space between each plate, and band-like connecting portions for connecting both ends of each of said arch-like plates in a longitudinal direction;
then, co-extrusion for said insert and forming material of a weather strip main body in a manner that said band-like connecting portions expose out of end edges of the reversed-U shape portions of said weather strip;
and, removing said band-like connecting portions to disconnect said arch-like plates inside the weather strip.
